(19) United States
(12) Patent Application Publication
(10) Pub. No.: US 2021/0067554 A1
(43) Pub. Date: Mar. 4, 2021

(54) REAL-TIME NOTIFICATIONS ON DATA BREACH DETECTED IN A COMPUTERIZED ENVIRONMENT

(71) Applicant: ItsMine Ltd., Herzliya (IL)

(72) Inventors: Ran NORMAN, Rishon LeTsiyon (IL); David ALLOUCH, Ra'anana (IL); Kfir KIMHI, Herzliya (IL); Guy BEN MAYOR, Rishon LeTsiyon (IL)

(73) Assignee: ItsMine Ltd., Herzliya (IL)

(21) Appl. No.: 17/010,321

(22) Filed: Sep. 2, 2020

Related U.S. Application Data
(60) Provisional application No. 62/895,129, filed on Sep. 3, 2019.

(51) Int. Cl. H04L 29/06

(52) U.S. Cl. CPC H04L 63/1491; H04L 63/0236; H04L 63/0823

(57) ABSTRACT

A system and method for real-time notifications of data breach in a computerized environment are provided. The method includes receiving a unique digital certificate, wherein the unique digital certificate includes an identifier utilized to initiate communication with the computing device upon a validation attempt of the unique digital certificate; associating the unique digital certificate with a first deceptive decoy element of a plurality of deceptive decoy elements deployed in a data source of the computerized environment; and generating a notification indicative of a data breach, in real-time, upon receipt of a request for validation of the unique digital certificate associated with the first deceptive decoy element, wherein the data breach is of the first deceptive decoy element; and sending the generated notification to at least one predetermined computerized source.

### CROSS-REFERENCE TO RELATED APPLICATIONS

This application claims the benefit of U.S. Provisional Application No. 62/895,129 filed on Sep. 3, 2019, the contents of which are hereby incorporated by reference.

### TECHNICAL FIELD

The present disclosure generally relates to data security, and more specifically, to a system and methods for real-time generation of a notification of a data breach in a computerized environment.

### BACKGROUND

Enterprises all over the world hold sensitive and confidential information related to their business, employees, and clients. The information is sometimes stored in simple folders in a computerized environment such as an enterprise network. In some countries, a data breach that occurs in an enterprise database, network, and the like may lead to a financial penalty. Moreover, the enterprise may be perceived as vulnerable, and clients and partners may not want to cooperate with a vulnerable enterprise.

Therefore, enterprises usually use many kinds of software to prevent data leakages and similar incidents. A common solution is the data leakage prevention (DLP) system also known as data loss prevention. The DLP system detects potential data breaches and prevents them by monitoring, detecting, and blocking sensitive data. In data leakage incidents, sensitive data is disclosed to unauthorized parties by either malicious intent or an inadvertent mistake. Sensitive data includes private or enterprise information, intellectual property (IP), financial or patient information, credit-card data, etc.

One disadvantage of the existing solutions for handling data breaches involves the cooperation with business unit owners and departments in the enterprise for adapting the DLP system to the enterprise policy, thus time consuming for personal required to review every reported breach. Another disadvantage of the DLP system is that it requires a lot of resources to maintain its functionality. In addition, the DLP systems usually interrupt employees' daily work as any access to sensitive folders would trigger an alert for both the user attempting to access the folder and for the security team required to review such alerts.

Another disadvantage of the DLP systems is that the integration of these systems usually takes several months, which expose the enterprise without protection against data threats during this period.

It would be advantageous to provide a solution that overcomes the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for method for real-time notifications of data breach in a computerized environment. The method comprises receiving a unique digital certificate, wherein the unique digital certificate includes an identifier utilized to initiate communication with a computing device in the computerized environment upon a validation attempt of the unique digital certificate; associating the unique digital certificate with a first deceptive decoy element of a plurality of deceptive decoy elements deployed in a data source of the computerized environment; generating a notification indicative of a data breach, in real-time, upon receipt of a request for validation of the unique digital certificate associated with the first deceptive decoy element, wherein the data breach is of the first deceptive decoy element; and sending the generated notification to at least one predetermined computerized source.

Certain embodiments disclosed herein include a system real-time notifications of data breach in a computerized environment. The system comprises a processing circuitry; a memory coupled to the processing circuitry, the memory contains therein instructions that when executed by the processing circuitry configure the system to: receive a unique digital certificate, wherein the unique digital certificate includes an identifier utilized to initiate communication with a computing device in the computerized environment upon a validation attempt of the unique digital certificate; associate the unique digital certificate with a first deceptive decoy element of a plurality of deceptive decoy elements deployed in a data source of the computerized environment; generate a notification indicative of a data breach, in real-time, upon receipt of a request for validation of the unique digital certificate associated with the first deceptive decoy element, wherein the data breach is of the first deceptive decoy element; and send the generated notification to at least one predetermined computerized source.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosure will be apparent from the following detailed description taken in conjunction with the accompanying drawings.

FIG. 1 is a network diagram utilized to describe various disclosed embodiments.

FIG. 2 is a flowchart illustrating a method for real-time generation of data breach notifications according to an embodiment.

FIG. 3 is a flowchart illustrating a method for real-time generation of a notification of a data activity event in a computerized environment according to an embodiment.

### DETAILED DESCRIPTION

It is important to note that the embodiments disclosed by the disclosure are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed method introduces a way for detecting data breaches in computerized environments and for generating in real-time notifications (alerts) respective thereof. In an example embodiment, a computing device receives a digital certificate (DC) that includes an identifier, such as uniform resource locator (URL) that is used for initiating communication with the computing device upon a validation attempt of the DC. The DC is associated with a selected file, e.g., a deceptive decoy element, that is deployed in a data source. Then, a notification is generated to indicate a data breach upon receipt of a request for validation of the DC. The request includes a serial number that is indicative of a metadata of the selected file and an internet protocol (IP) address of an end-point device of the computerized environment from which the request was sent. The notification contains therein at least the metadata and the IP address.

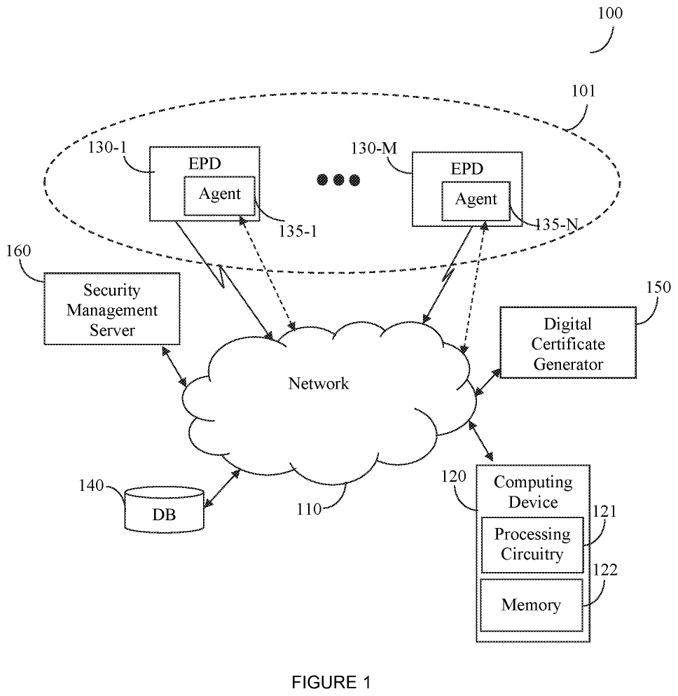

FIG. 1 depicts a network diagram 100 utilized to describe various disclosed embodiments. A network 110 is used to enable communication between the different components of the network diagram 100. The network 110 may be, but is not limited to, a local area network (LAN), a wide area network (WAN), a metro area network (MAN), the world wide web (WWvV), the Internet, a wired network, a wireless network, and the like, as well as any combination thereof. A computing device 120 is connected to the network 110. The computing device 120 may be a computer hardware and software component configured to execute predetermined computing tasks. The computing device 120 includes a processing circuitry 121 and a memory 122.

The processing circuitry 121 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 122 may be a volatile memory such as, but not limited to, Random Access Memory (RAM). In an embodiment, the memory 122 is configured to store software for execution by the processing circuitry 121. Software shall be construed broadly to mean any type of instructions, whether referred to as software, firmware, middleware, microcode, hardware description language, or otherwise noted. Instructions may include code (e.g., in source code format, binary code format, executable code format, or any other suitable format of code). The instructions, when executed by the one or more processors, cause the processing circuitry 121 to perform the various processes described herein and, in particular, configure the system to provide real time notifications of data breaches in a computerized environment 101 in accordance with one or more of the disclosed embodiments.

A plurality of end point devices (EPD) 130-1 through 130-M, where M is an integer equal to or greater than 1, are communicatively connected to the network 110. The EPDs 130 can be, but are not limited to, smart phones, mobile phones, laptops, tablet computers, wearable computing devices, personal computers (PCs), a combination thereof and the like. A plurality of agents 135-1 through 135-N may be installed on the respective EPDs 130 and may be further connected to the network 110.

A database 140 may also be connected to the network 110. The database 140 is configured to store therein, for example, data related to location of deceptive decoy elements and/or sensitive files that were previously deployed in one or more data source’ of the computerized environment. A data source may include structured or unstructured data. The data source may include a folder, a file, or any piece of data. According to another embodiment, the database 140 is configured to store therein data that indicates a connection between a digital certificate and a deceptive decoy element, and so on. A deceptive decoy element may be a data element, such as a data file, that is designed to simulate a regular data element, e.g. a data file. However, the deceptive decoy element does not include any confidential or necessary information. The deceptive decoy element is placed in, for example, a folder of a file system of the computerized environment 101.

A digital certificate generator (DCG) 150 may be further connected to the network 110. The DCG 150 may be, for example, a server that is configured to generate unique digital certificates. Each unique digital certificate includes at least a uniform resource locator (URL) that is used for initiating communication with a predefined computing device, e.g., the computing device 120, upon a validation attempt of the unique digital certificate, as further described herein below. According to an embodiment, the computing device 120 may be used for generating the unique digital certificates.

A security management server (SMS) 160, e.g., a server, may be also connected to the network 110. The SMS 160 may be configured to, for example, receive notifications and alerts in connections with data breaches and suspected behaviors in the computerized environment 101 and display these notifications and alerts. In an example embodiment, the SMS 160 may include a security information and event management (SIEM) system, and the like.

According to an embodiment, the computing device 120 is configured to execute the disclosed embodiments including at least generating real-time notification of the data breach. To this end, the computing device 120 is configured to receive a unique digital certificate. The unique digital certificate may be generated by the DCG 150. A digital certificate is an electronic version of an identification card that allows a secured exchange of data between two network entities. The unique digital certificate may include at least a uniform resource locator (URL).

A URL may indicate the location of a resource, e.g., the computing device 120 internet protocol (IP) address, as well as the protocol used to access it. The URL may be used to initiate communication with the computing device 120 upon a validation attempt of the unique digital certificate. The unique digital certificate may include, for example, a certificate revocation list (CRL), an online certificate status protocol (OCSP), etc. The CRL is a list of digital certificates that have been revoked by an issuing certificate authority (CA) before their scheduled expiration date and should no longer be trusted. The OCSP is an Internet protocol used to determine the state of an identified certificate.

In an embodiment, the computing device 120 may be configured to associate the unique digital certificate with a first deceptive decoy element of a plurality of deceptive decoy elements deployed in a data source’ the computerized environment 101. The first deceptive decoy element is a data element, such as a data file, that is designed to simulate a regular data element, e.g. a data file. However, the first deceptive decoy element does not include any confidential or necessary information. The first deceptive decoy element is deployed in a data source (e.g., a folder of a file system) of the computerized environment. The data source may contain data associated with different matters such as, finance, marketing, human resources, and the like, that may include sensitive information that should be protected against data threats.

The computerized environment 101 may include, for example, a plurality of EPDs 130 communicatively connected by an enterprise network, e.g., the network 110. Each one of the EPD 130 may be able to access the data source. It should be noted that, the plurality of deceptive decoy elements may be generated by the computing device 120 and thereafter deployed by the computing device 120 in data sources of the computerized environment, as further discussed herein below. According to another embodiment, the computing device 120 may select a deceptive decoy element for use from a database, e.g., the database 140, receive the deceptive decoy elements from a designated deceptive decoy elements generator, and the like.

The computing device 120 may be configured to receive a request for validation of the unique digital certificate that is associated with the first deceptive decoy element. The request may be sent by a software by which the deceptive decoy element is handled, e.g., opened on an end-point device, e.g., the EPD 130-1. For example, a deceptive decoy element is handled by an end-point device that is associated with an entity (e.g., a person), and specifically, a software such as Adobe® is selected and used for opening the deceptive decoy element, without knowing that the deceptive decoy element does not include any confidential or necessary information. According to the same example, when the software, e.g., Adobe®, identifies that the file (the deceptive decoy element) is associated with a unique digital certificate, the software communicates, using at least the URL that is indicated in the unique digital certificate, with the computing device 120 to which the URL leads.

It should be noted, the request is sent to the computing device 120 for validating the unique digital certificate, however the validation is not the purpose. In an embodiment, the request may include a serial number that is indicative of a metadata of the first deceptive decoy element and an internet protocol (IP) address of an end-point device of the computerized environment from which the request was sent. Serial numbers may be associated with each of the plurality of deceptive decoy elements.

The association of the serial numbers with the deceptive decoy elements may occur when the deceptive decoy elements are generated by the computing device 120, received by the computing device 120, and the like. The metadata of the first deceptive decoy element (DDE) may include time at which the DDE has been generated, the DDE location in the computerized environment, the DDE properties, which entity or entities handled the DDE (opened, downloaded, etc.) or open the data source at which the DDE is located, and so on. The IP address of the end-point device from which the request was sent, e.g., the end-point device 130-1, may be used to track the entity (person, department, etc.) that is associated with the end-point device 130.

In an embodiment, the computing device 120 may be configured to generate a notification to indicate a data breach upon receiving the request for validation of the unique digital certificate. The notification may include the metadata of the first deceptive decoy element and the IP address of the end-point device from which the request was sent.

In a further embodiment, the computing device 120 may be configured to send the generated notification to a predetermined computerized source such as, the security management server 160, a security information and event management (SIEM) system, and the like. As further discussed herein, the notification may include the IP address of the end-point device from which the request was sent as well as metadata that is associated with the first deceptive decoy element such as, time at which the DDE was generated, the DDE location in the computerized environment, the DDE properties, which entity or entities handled the DDE (opened, downloaded, etc.) or open the data source at which the DDE is located, and so on.

In an embodiment, the computing device 120 may be configured to annihilate the first DDE, and any other DDE, after a predetermined time period, for example, after 24 hours. Thus, when a DDE is triggered, a defined time range, at which the DDE has been active, may assist in investigating the data breach. For example, if a DDE having a 12 hours life cycle was generated and thereafter deployed in a certain data source on Jan. 10, 2019 at 10:00 AM, and the same DDE was triggered by some entity, the computing device 120 may be configured to determine that the data breach occurred on Jan. 10, 2019 between 10:00 AM and 10:00 PM. It should be noted that when a first DDE is annihilated, a new DDE may be deployed in its place. Thus, a sequence of DDEs, that are deployed in strategic predetermined locations within the computerized environment, may be retained. Such sequence allows a rapid and accurate determination of a data breach. A record of each active DDE or annihilated DDE may be stored in a log file for facilitating an effective and rapid investigation of a data breach in the computerized environment. The log file may be stored in, for example, the database 140.

As a non-limiting example, a unique digital certificate is associated with a DDE that is deployed in a finance department data source. When the DDE is triggered, e.g., opened, by an employee or an external attacker, the computing device 120 receives a request that is sent by the software that was utilized for, for example, opening the DDE. According to the same example, the request indicates (a) an IP address of an end-point device that is associated with an employee of the marketing department of the company, and (b) a serial number that has been previously associated with the DDE. The serial number facilitates the computing device 120 to determine that the deceptive decoy element was created 10 hours ago, that the DDE was deployed in the finance data source, and the like.

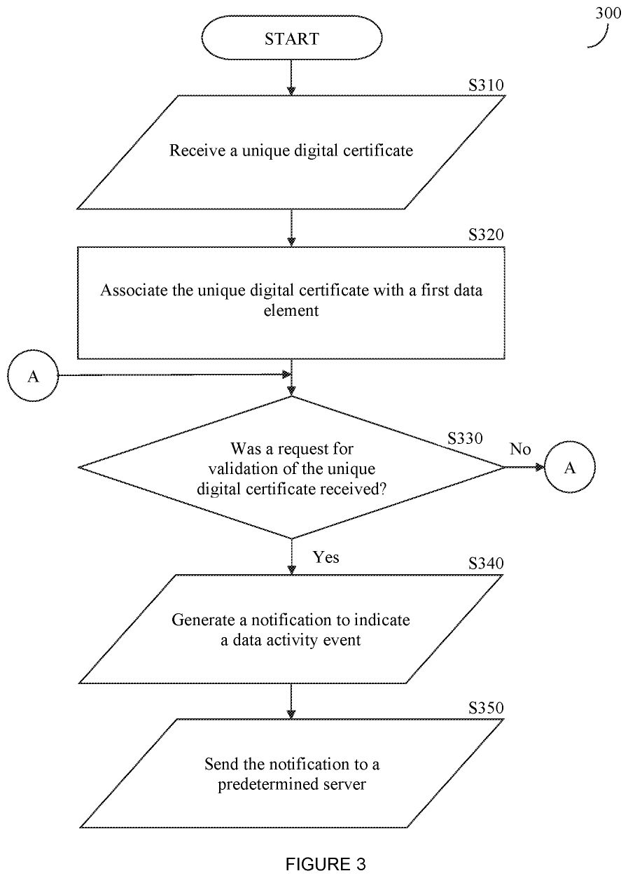

According to one embodiment, and as further discussed in FIG. 3, the received unique digital certificate may be associated with a regular data element, i.e., a regular file. The motivation for associating such regular files with a unique digital certificate may include for example, protecting sensitive files from being disclosed to unauthorized entities. Thus, when the regular file, to which the unique digital certificate is associated, is triggered the request for validation is sent to the computing device 120.

The computing device 120 is configured to send a notification to a predetermined computerized source, e.g., the security management server 160. The notification may include the IP address from which the request was sent, as well as a serial number of the regular file that was previously selected. In an embodiment, after receiving a validation request with respect to the regular file, the computing device 120 may search in an authorizations list whether the end-point device, by which the regular file was handled, is authorized or not to open, download, etc. the regular file.

According to an embodiment, the computing device 120 is configured to generate the plurality of deceptive decoy elements. A deceptive decoy element is data element, such as a data file, that is designed to simulate a regular data element, e.g. a data file. However, the deceptive decoy element does not include any confidential or necessary information. The deceptive decoy element is deployed in data sources, such as, data sources of a file system of the computerized environment and is configured to provide an electronic indication of unauthorized access upon an attempt to be handled by an entity.

In order to generate the deceptive decoy element, the computing device 120 is configured to collect information corresponding to the data source of the of the computerized environment. The information may refer to the data source's content (e.g., files), and may include the files' names, creation date, date modified, size, type, language, amount, and so on. For example, a folder associated with an enterprise finance department may contain 700 files that have similar properties that may indicate that all of the files were created during the same year, the files' average size is 215 kilobytes (KB).

The computing device 120 may be configured to analyze the information associated with the data sources in order to determine the properties of the data sources. The analysis may include calculating the files' size for identifying the files' average size, comparing the filenames to a set of predetermined keywords that enable categorization of each of the data source, and the like.

The computing device 120 is configured to generate a deceptive decoy based on the determination of the data source's properties. For example, the computing device 120 may determine that a certain folder contains 200 PDF files having an average size of 1,045 KB, created in 2017, having keywords related to marketing. Then, the computing device 120 is configured to generate 60 deceptive decoy elements. According to the same example, one of the 60 deceptive decoy elements may be a 1,015 KB PDF file, having keywords relate to marketing, having a creation date from 2017, and the like.

The computing device 120 is further configured to deploy the generated deceptive decoy element in the data source. The deployment is based on a sensitivity level of the data source. For example, upon determination that a certain data source includes a low value information, the computing device 120 may deploy 0-10% of deceptive decoy elements within the data source, which is a low risk data source. According to the same example, in case the data source includes a medium value information, the computing device 120 may deploy 10-30% of deceptive decoy elements, and in case the folder includes a high value information, the computing device 120 may deploy 30-50% of deceptive decoy elements.

In order to determine the sensitivity level of the data source, the computing device 120 is configured to collect information related to the folder, and analyze the information for determining the sensitivity level of the data source. The analysis of the information may include checking whether one or more items exist in the information, such as a certain keyword, identifiers, and the like, that indicate that the folder contains confidential or restricted information. The analysis may further include checking the identity of the entity that handled the files related to the folder, checking how this entity reached the folder, whether the entity is a user or a computer, and the like. In addition, the analysis may further include checking whether one or more parameters in the folder have exceeded a predetermined value, for example, in case there are more than two social security numbers stored therein, the folder may be categorized as a high-risk folder.

In an embodiment, the computing device 120 may be configured to constantly monitor the information corresponding to the data source for determining whether changes have occurred within the folder. For example, a data source categorized as a low risk data source on a certain date may be categorized as high-risk folder, i.e., containing high value information, on the following day. The reasons for such a change may be the addition of one or more confidential files to the folder, the identity of the entities that handled the folder between these days, and the like.

In an embodiment, based on the determination that a change that requires a different sensitivity level has occurred, the computing device 120 may update the sensitivity level of the data source. According to a further embodiment, the computing device 120 updates the deployment of the at least one deceptive decoy element based on the updated sensitivity level of the folder. For example, in case a low risk folder contains 1% of deceptive decoy elements, after the sensitivity level increases and is updated respectively, the computing device 120 may deploy 25% of deceptive decoy elements in the folder.

According to another embodiment, the deployment of the deceptive decoy elements may be executed on computer-based local systems, computer-based cloud systems, such as Microsoft® One Drive, Google® Drive, and the like, and on structured data environment such as enterprise resource planning (ERP) systems. It should be noted that when no folders exist, e.g. when handling structured data, the deceptive decoy elements may be deployed in a data source at which data elements, e.g. files, are stored and not within a specific folder.

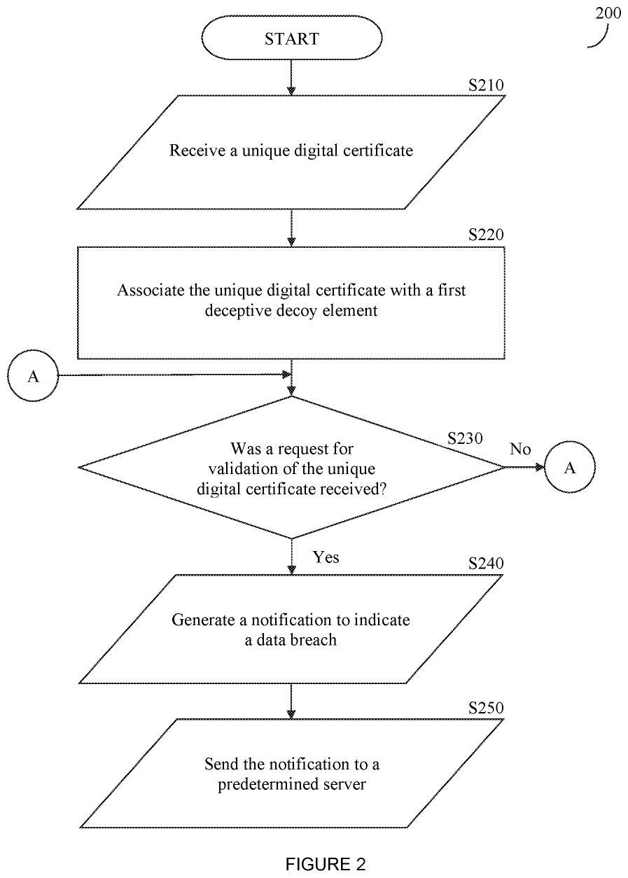

FIG. 2 is an example flowchart 200 describing a method for real-time generation of notifications of data breaches detected in a computerized environment 101 according to an embodiment. In an embodiment, the method may be executed by the computing device 120.

At S210, a unique digital certificate is received. The unique digital certificate includes at least a uniform resource locator (URL). The URL is used to initiate communication with a computing device, e.g., the computing device 120, upon a validation attempt of the unique digital certificate.

At S220, the unique digital certificate is associated with a first deceptive decoy element of a plurality of deceptive decoy elements deployed in at least a folder of a file system of the computerized environment.

At S230, it is checked whether a request for validation of the unique digital certificate is received, and if so execution continues with S240; otherwise, the computing device 120 constantly check whether a request for validation of the unique digital certificate was received.

At S240, upon receipt of the request for validation of the unique digital certificate, a notification indicating a data breach is generated. The request includes at least a serial number that is indicative of a metadata of the first deceptive decoy element and an internet protocol (IP) address of an end-point device of the computerized environment from which the request was sent, as further discussed herein above with respect of FIG. 1.

At S250, the notification is sent to a predetermined computerized source, e.g., the security management server 160 (FIG. 1). In an embodiment, the notification may be displayed on a display (not shown) that is coupled to the security management server 160.

FIG. 3 is an example flowchart 300 describing a method for real-time generation of a notification of a data activity event in a computerized environment according to an embodiment. In an embodiment, the method may be executed by the computing device 120.

At S310, a unique digital certificate is received. The unique digital certificate includes at least a uniform resource locator (URL). The URL is used to initiate communication with a computing device, e.g., the computing device 120, upon a validation attempt of the unique digital certificate.

At S320, the unique digital certificate is associated with a first data element of a plurality of data elements associated with a data source. For example, the first data element may be a file associated with a folder of a file system of the computerized environment. Some data files may include confidential or necessary information. The data elements that should be protected and monitored may be previously selected by the computing device 120 and/or by an authorized user.

At S330, it is checked whether a request for validation of the unique digital certificate is received and if so, execution continues with S340; otherwise, periodic checks are made to check if such a request was made.

At S340, upon receipt of the request for validation of the unique digital certificate, a notification indicating a data activity event, is generated. Data Activity event may include for example, an event at which a predetermined sensitive file was triggered, e.g. opened by an authorized or unauthorized entity. The request may include an identifier, e.g. a serial number or the name of the first data element, that is indicative of a metadata of the first data element and an internet protocol (IP) address of an end-point device of the computerized environment from which the request was sent, as further discussed herein above with respect of FIG. 1.

At optional S350, the notification is sent to a predetermined computerized source, e.g., the security management server 160 (shown in FIG. 1). In an embodiment the notification may be displayed on a display (not shown) that is coupled to the security management server 160. In an embodiment, multiple actions may be performed by the computing device 120 upon identifying a data activity event, such as, blocking the access to the data file when the IP address is not valid, recording the actions made by the end-point device that was used for triggering the data element, etc.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

What is claimed is:

1. A method for real-time notifications of data breach in a computerized environment, comprising:
receiving a unique digital certificate, wherein the unique digital certificate includes an identifier utilized to initiate communication with a computing device in the computerized environment upon a validation attempt of the unique digital certificate;
associating the unique digital certificate with a first deceptive decoy element of a plurality of deceptive decoy elements deployed in a data source of the computerized environment;
generating a notification indicative of a data breach, in real-time, upon receipt of a request for validation of the unique digital certificate associated with the first deceptive decoy element, wherein the data breach is of the first deceptive decoy element; and
sending the generated notification to at least one predetermined computerized source.

2. The method of claim 1, wherein the request comprises at least a serial number of the first deceptive decoy element and an internet protocol (IP) address of an end-point device of the computerized environment from which the request was sent.

3. The method of claim 1, wherein the generated notification includes a serial number and a network address of the computing device.

4. The method of claim 1, further comprising:
annihilating the first deceptive decoy element after a predetermined time period.

5. The method of claim 1, wherein the identifier is at least a uniform resource locator (URL).

6. The method of claim 1, wherein the deceptive decoy element is a data element simulating an existing data element in the data source.

7. The method of claim 1, wherein the data source is at least a folder of a file system, the deceptive decoy element is a data file.

8. A non-transitory computer readable medium having stored thereon instructions for causing a processing circuitry to execute a process for time notifications of data breach in a computerized environment, comprising:
receiving a unique digital certificate, wherein the unique digital certificate includes an identifier utilized to initiate communication with a computing device in the computerized environment upon a validation attempt of the unique digital certificate;
associating the unique digital certificate with a first deceptive decoy element of a plurality of deceptive decoy elements deployed in a data source of the computerized environment;
generating a notification indicative of a data breach, in real-time, upon receipt of a request for validation of the unique digital certificate associated with the first deceptive decoy element, wherein the data breach is of the first deceptive decoy element; and
sending the generated notification to at least one predetermined computerized source.

9. A system real-time notifications of data breach in a computerized environment, comprising:
a processing circuitry;
a memory coupled to the processing circuitry, the memory contains therein instructions that when executed by the processing circuitry configure the system to:
receive a unique digital certificate, wherein the unique digital certificate includes an identifier utilized to initiate communication with a computing device in the computerized environment upon a validation attempt of the unique digital certificate;
associate the unique digital certificate with a first deceptive decoy element of a plurality of deceptive decoy elements deployed in a data source of the computerized environment;
generate a notification indicative of a data breach, in real-time, upon receipt of a request for validation of the unique digital certificate associated with the first deceptive decoy element, wherein the data breach is of the first deceptive decoy element; and
send the generated notification to at least one predetermined computerized source.

10. The system of claim 9, wherein the request comprises at least a serial number of the first deceptive decoy element and an internet protocol (IP) address of an end-point device of the computerized environment from which the request was sent.

11. The system of claim 9, wherein the generated notification includes a serial number and a network address of the computing device.

12. The method of claim 1, wherein the system is further configured to:
annihilate the first deceptive decoy element after a predetermined time period.

13. The system of claim 1, wherein the identifier is at least a uniform resource locator (URL).

14. The system of claim 1, wherein the deceptive decoy element is a data element simulating an existing data element in the data source.

15. The system of claim 1, wherein the data source is at least a folder of a file system, the deceptive decoy element is a data file.
